(19) United States
(12) Patent Application Publication
(10) Pub. No.: US 2018/0232783 A1
(43) Pub. Date: Aug. 16, 2018

(54) Web-Push Notification Advertising Network System

(71) Applicant: HODo Mobile Multimedia Co., Ltd, Taipei City 104 (TW)

(72) Inventors: Chih Yao Lin, Taipei City (TW); Tzu-Ming Lin, Taipei City (TW); Chia-Hung Tsou, Taipei City (TW); Wei-Kuang Lai, Taipei City (TW)

(21) Appl. No.: 15/648,536

(22) Filed: Jul. 13, 2017

(30) Foreign Application Priority Data
Feb. 13, 2017 (TW) 106104575

(51) Int. Cl. G06Q 30/02; H04L 29/08; G06F 17/30

(52) U.S. Cl. CPC G06Q 30/0277; H04L 67/26; G06Q 30/0257; G06F 17/30879; G06F 17/30887; H04L 67/02

(57) ABSTRACT

A web-push notification advertising network system comprises a plurality of secondary servers, a plurality of receiving ends, a plurality of push-notification ends and a main server. Each of the secondary servers has a different domain name, and further includes a push-notification function module. Each of the receiving ends is connected to at least one of the secondary servers. Each of the secondary servers is connected to at least one of the push-notification ends; and the main server includes a database. The database stores user information of all the receiving ends. wherein, the push-notification end sends a push notification message to the corresponding receiving end by the push-notification function module through the secondary server. The secondary server sends to the push notification message to the non-corresponding receiving ends through the main server. Then, the push notification message is sent to other receiving ends via the other secondary servers.

### FIELD OF THE INVENTION

The present invention relates to an advertising network, more particularly to a web-push notification advertising network system sending web-push notification messages, and identifying push notification users via a domain.

### BACKGROUND OF THE INVENTION

A push technology means an important message could be still transmitted by a backstage into a mobile device or a computer of a user when a web page or an app is turned off by the user. The push technology is widely used to several types of the application software, so using the push technology as advertising purposes is a common sale method.

Therefore, that the effect of the push technology is good or bad depends on how many users can receive push notification messages. However, currently the app or the application software is the end of the diversion pipeline. If the number of users using the apps is insufficient, the effect of the push technology is also limited.

The web browser is used by most users. Most of the apps or the application software are downloaded via the web browser. In other words, the web browser is an important traffic gathering place. The effect of the push technology would be improved when the push technology is used via the web browser. Therefore, the push technology via the web browser is a mainstream program in the future.

However, the advertising program of the push technology is often used to a large web page at present. For example, new article or advertising message is pushed into the news network via the push technology. But the push technology is not appropriate for a small web page (e.g., fans, personal pages or blogs). The cost of the push notification server used to fans, personal pages or blogs is too high. The small web would be a problem when a web page push system become a web-push notification advertising network system.

Therefore, how to overcome the above problems is worthy to be considered by the person having ordinary skill in the art.

### SUMMARY OF THE INVENTION

In view of the above problems, a web-push notification advertising network system is provided. A push notification service could be sent to a plurality of different push notification users via the secondary servers.

A web-push notification advertising network system comprises a plurality of secondary servers, a plurality of receiving ends, a plurality of push-notification ends and a main server. Each of the secondary servers has a different domain name, and further includes a push-notification function module. Each of the receiving ends is connected to at least one of the secondary servers. Each of the secondary servers is connected to at least one of the push-notification ends; and the main server includes a database. The database stores user information of all the receiving ends. wherein, the push-notification end sends a push notification message to the corresponding receiving end by the push-notification function module through the secondary server. The secondary server sends to the push notification message to the non-corresponding receiving ends through the main server.

In the web-push notification advertising network system, the receiving end receives the push notification message by a webpage browser.

In the web-push notification advertising network system, the receiving end completes a subscription from the secondary server, so that the push notification message is received from the secondary server.

In the web-push notification advertising network system, the receiving end completes a subscription according to the webpage corresponding to the secondary server.

In the web-push notification advertising network system, the secondary server displays a banner advertisement on the receiving end, so that when a user clicks the banner advertisement, the subscription is completed by confirmation.

In the web-push notification advertising network system, the receiving end shoots a barcode symbol to obtain a URL link and connect to the corresponding secondary server to complete the subscription.

In the web-push notification advertising network system, the push-notification function module comprises a push-notification editing module and a push-notification sending module. The push-notification editing module is applicable for editing the push notification message. The push-notification sending module is applicable for sending the push notification message.

In the web-push notification advertising network system, the user information includes the secondary server subscribed by the receiving end.

### BRIEF DESCRIPTION OF THE DRAWINGS

FIG. 1 is a schematic block diagram of a web-push notification advertising network system of the present invention;

FIG. 2A is a schematic block diagram of a secondary server of a first preferred embodiment of the present invention;

FIG. 2B is a schematic block diagram of a secondary server of a second preferred embodiment of the present invention;

FIG. 2C is a schematic block diagram of a secondary server of a third preferred embodiment of the present invention;

FIGS. 3A to 3C are schematic block diagrams of a web-push notification advertising network system of a preferred embodiment of the present invention;

FIGS. 4A and 4B are schematic views of a subscription in accordance with a preferred embodiment of the present invention;

FIGS. 5A to 5C are schematic views of another subscription in accordance with a preferred embodiment of the present invention; and

FIGS. 6A and 6B are schematic views of a further subscription in accordance with a preferred embodiment of the present invention.

### DETAILED DESCRIPTION OF PREFERRED EMBODIMENTS

The present invention provides a web-push notification advertising network system 100. The web-push notification advertising network system 100 builds up a plurality of websites or webpages, and advertisement broadcasting companies send a push notification message in form of a webpage push-notification through these websites or webpages to consumer ends, so as to achieve an advertising effect.

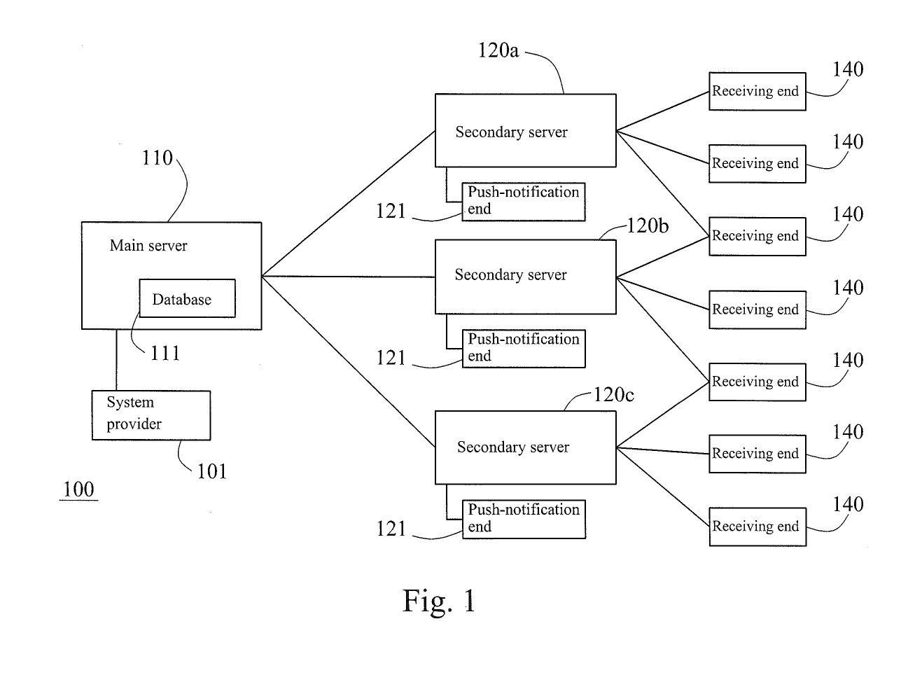

With reference to FIG. 1 for a schematic block diagram of a web-push notification advertising network system in accordance with the present invention, the web-push notification advertising network system 100 comprises a main server 110, a plurality of secondary servers 120, a plurality of push-notification ends 121, and a plurality of receiving ends 140. The main server 110 is a control end of a system provider 101, and the main server 110 is connected to a plurality of secondary servers 120, and the main server 110 is capable of reading data from the secondary server 120, particularly reading the related data of the receiving end 140. In this preferred embodiment, the main server 110 further includes a database 111 for storing user information (such as the information on which receiving end 140 subscribes which secondary server 120) of each receiving end 140.

The secondary server 120 is a server provided for a push notification user 102 to use the webpage push-notification. Each secondary server 120 has a different domain name, wherein the domain name may be a name corresponding to the webpage of the push notification user 102. For example, the corresponding domain name of China Times News Network is Chinatimes.com. As to the consumer users of the receiving end 140, they can receive the push notification message from Chinatimes.com through the receiving end 140. In addition, the secondary server 120 can identify through which part of the webpage that the receiving end 140 subscribes the secondary server 120, and distinguish the source of the receiving end 140 accordingly. In the news information network of the aforementioned preferred embodiment, the secondary server 120 can identify that the receiving end 140 completes the subscription when browsing a certain type of news. For example, the receiving end 140 completes the subscription when browsing entertainment news, and thus the secondary server 120 classifies the receiving end 140 into the category of entertainment news.

The receiving end 140 is a using terminal of a consumer user. In this preferred embodiment, the receiving end 140 is an electronic device such as a smart phone, a tablet PC, a personal computer, or a device for browsing a webpage through a browser. In other words, the receiving end 140 can receive the push notification message through the browser. When the receiving end 140 is connected to the secondary server 120 through a browser, the receiving end 140 will receive a request for receiving the push notification message from the secondary server 120. Once the consumer user permits the receipt of the push notification message, the receiving end 140 will subscribe a push notification message of the secondary server 120.

Each secondary server 120 is connected to at least one push-notification end 121, and whose push-notification end 121 is a using terminal of the push notification user 102, so that the secondary server 120 further includes a push-notification function module. In other words, after the push-notification end 121 is connected to the secondary server 120, the push-notification function module may be used to edit the push notification message including the content such as drawings, photos, links, etc of the push notification message and send the push notification message. The sending target may be a receiving end 140 corresponding to the secondary server 120 (which is the receiving end 140 subscribing the secondary server 120), or a part of the specific receiving end 140.

In a preferred embodiment, the push-notification function module of the secondary server 120 includes a push-notification editing module and a push-notification sending module. The push-notification editing module is provided for the push-notification end 121 to edit the push notification message, and the editable items include the caption, content, included drawings or link of the push-notification. The push-notification sending module is provided for the push-notification end 121 to send the push notification message to the specific receiving end 140.

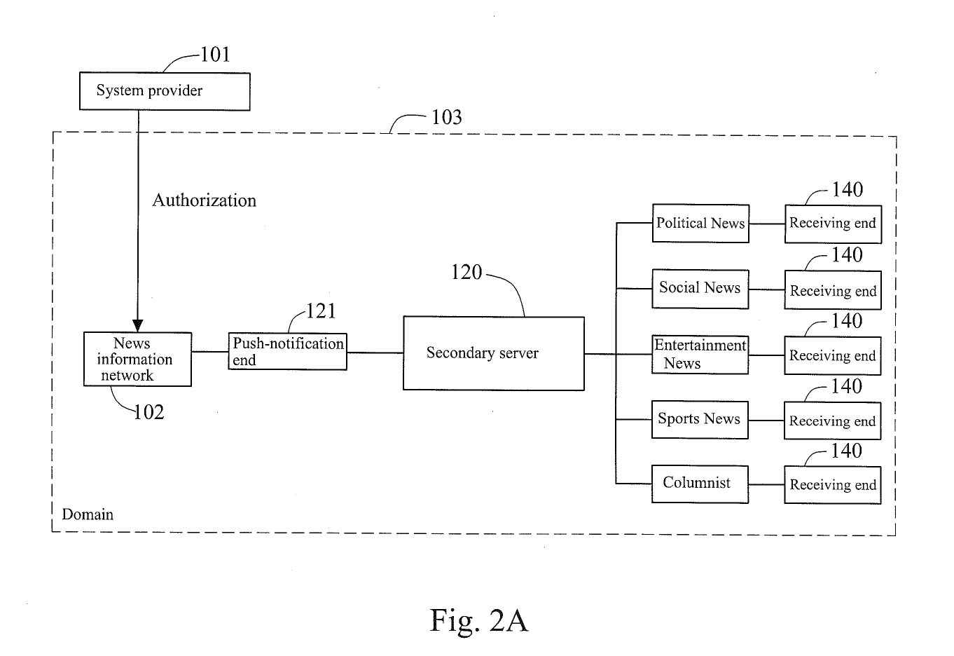

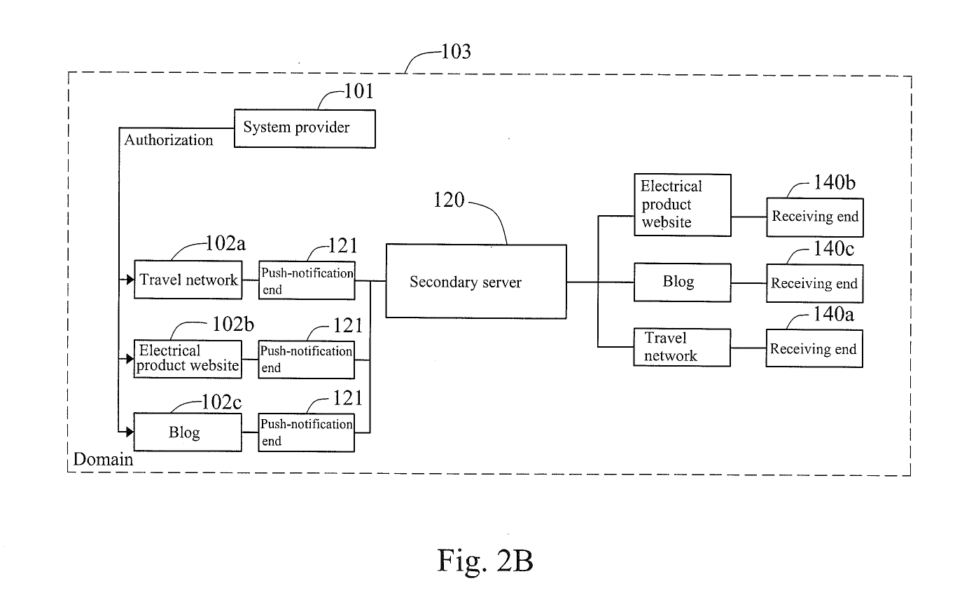

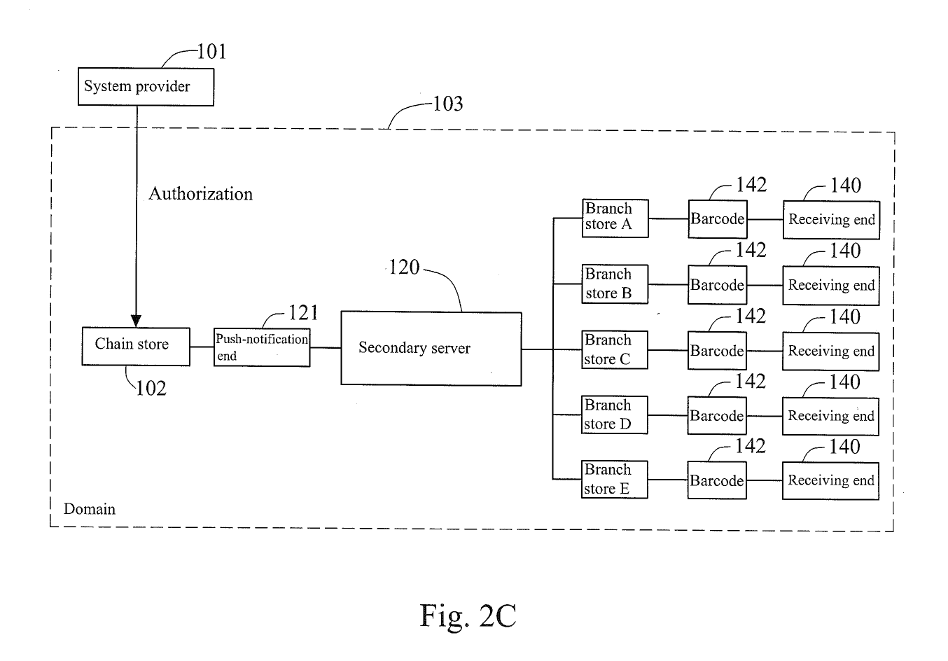

With reference to FIG. 2A for a secondary server in accordance with the first preferred embodiment of the present invention, the system provider 101 authorizes the push notification user 102 to use the push notification service of the secondary server 120. Therefore, the push notification user 102 can use the push notification service in a domain 103 of the secondary server 120 to send the push notification message to the plurality of receiving ends 140. The receiving ends 140 may complete a subscription by browsing the webpage corresponding to the secondary server 120, and the secondary server 120 can determine the subscription source of the receiving end 140 and classify the category of the receiving end 140, and allow the push-notification end 121 to select a push-notification target. In FIG. 2A, the push notification user 102 of this preferred embodiment is a news information network, so that the secondary server 120 can determine that the receiving end 140 completes the subscription through browsing a webpage of political news, social news, entertainment news, sports news, columnist, etc and the receiving end 140 can be classified into different categories such as political news, social news, entertainment news, sports news, columnist, etc.

With reference to FIG. 2B for a schematic block diagram of a secondary server in accordance with the second preferred embodiment of the present invention, the system provider 101 authorizes a plurality of different push notification users 102 to use the push notification service of the secondary server 120 in the domain 103. In other words, the push notification users 102a-102c share one domain 103 to use the push notification service. Therefore, the push notification messages received by the receiving end 140 are from the same domain name.

Although the push notification users 102a-102c of the second preferred embodiment share a domain 103, yet the secondary server 120 identifies the subscription source of the receiving end 140, so that the push notification users 102 can send the push notification message to the corresponding receiving end 140 only. For example, the push notification user 102a of the travel network can send the push notification message to the corresponding receiving end 140a only. In another preferred embodiment, the push notification users 102 still can send the push notification message to other receiving ends 140 under the authorization of the system provider 101. For example, the system provider 101 permits the push notification user 102a of the travel network to send a push notification message to the receiving end 140c of a subscribed blog to achieve the advertising effect.

With reference to FIG. 2C for a schematic block diagram of a secondary server in accordance with the third preferred embodiment of the present invention, the third preferred embodiment is substantially the same as the first preferred embodiment, and the system provider 101 authorizes the push notification users 102 to use the push notification service of the secondary server 120, and permits the push notification users 102 to use the push notification service under the domain 103 of the secondary server 120. This preferred embodiment is characterized in that the receiving end 140 completes a subscription by shooting a barcode symbol 142, obtaining an URL link, and connecting to the secondary server 120 through the URL link. In other words, the barcode symbol 142 includes the URL link, and the URL link carries different identification codes provided for the secondary server 120 to identify the subscription source of the receiving end 140. For example, the push notification user 102 of this preferred embodiment is a chain store, and the barcode symbols 142 representing branch stores of the chain store at different locations respectively and provided for a consumer user to shoot in order to subscribe a push-notification service, so as to manage the consumer groups of different branch stores, or push regional marketing activities or notification messages.

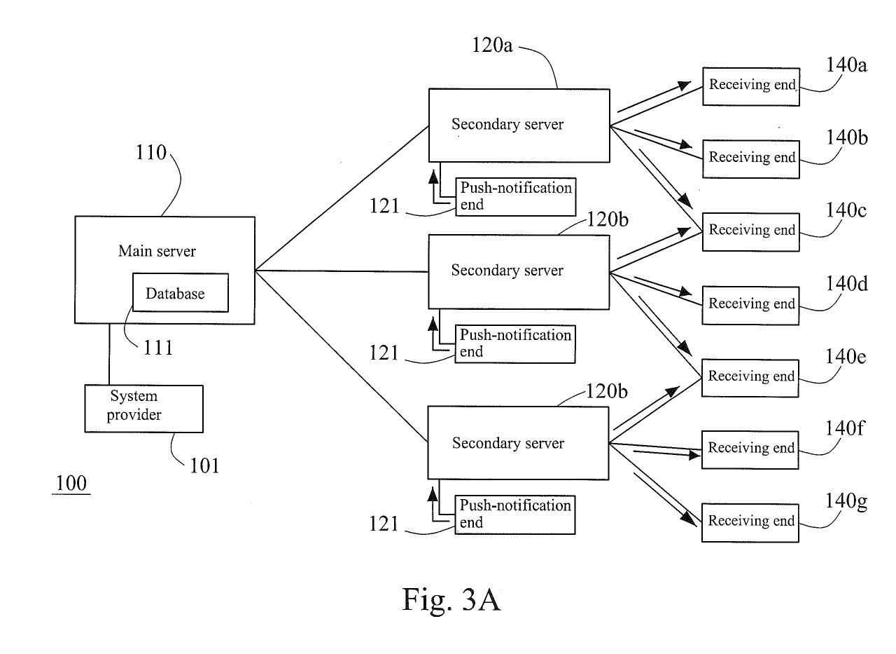

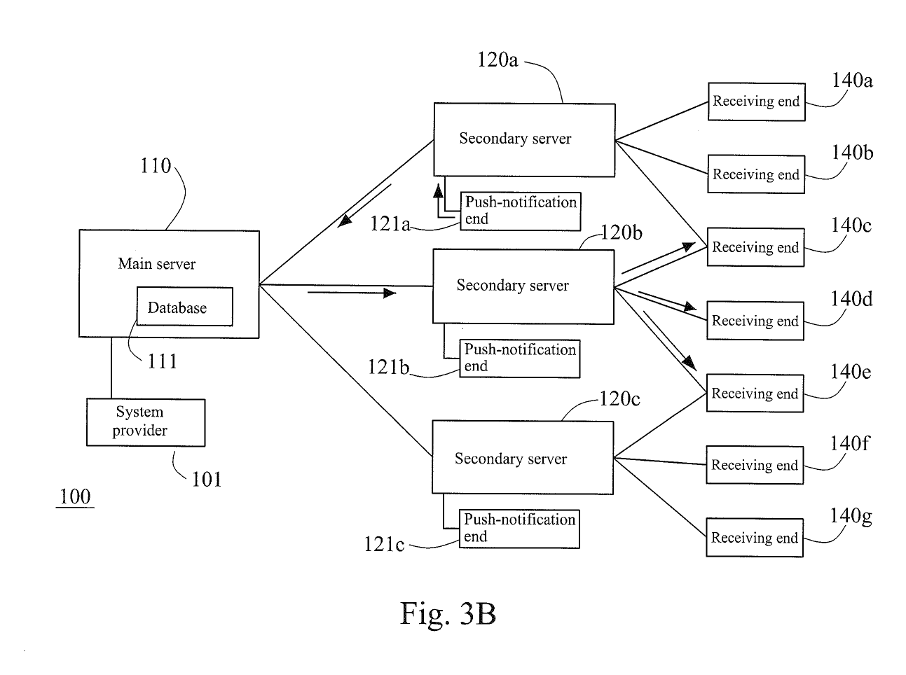

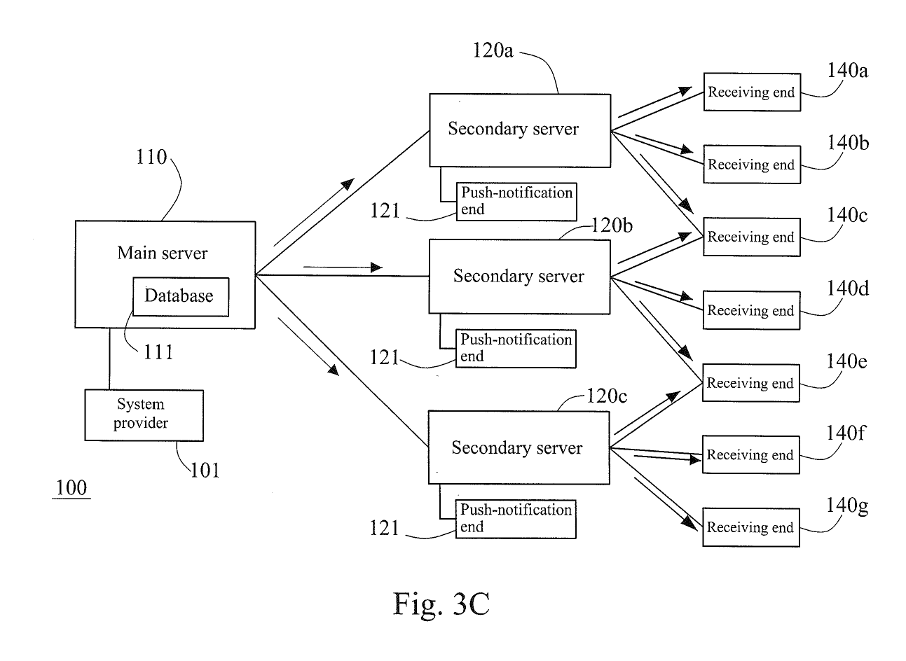

With reference to FIGS. 3A to 3C for the schematic block diagrams of a web-push notification advertising network system in accordance with a preferred embodiment of the present invention, FIG. 3A shows the general conditions of a web-push notification advertising network system 100, and each push-notification end 121 sends a push notification message to the corresponding receiving ends 140a-140g through the secondary server 120. FIG. 3B shows an inter-webpage push-notification in accordance with other embodiments, the push-notification end 121 may send a request to the main server 110 to send the push notification message to other receiving ends 140 of the secondary server 120. If the main server 110 grants the request of the push-notification end 121, the push-notification end 121 can send the push notification message to the non-corresponding receiving ends 140 through the main server 110. In the preferred embodiment as shown in FIG. 3B, the push-notification end 121a of the secondary server 120a submits a request to the main server 110. After granting the request, the main server 110 sends the push notification message set by the push-notification end 121a to another secondary server 120b to subscribe the receiving ends 140c-140e of the secondary server 120b, so that the push notification message set by the push-notification end 121a can be received.

With reference to FIG. 3C for a schematic block diagram of a full-platform push-notification of a preferred embodiment, the main server 110 can send a push notification message, wherein the main server 110 sends the push notification message to all receiving ends 140a-140g. In other preferred embodiments, the main server 110 may select a push-notification target in order to send the push notification message to a specific receiving end 140.

In the application as shown in FIGS. 3A to 3C, the push notification message can be transmitted among a plurality of webpages through the web-push notification advertising network system 100, so that the push notification message can be sent to more receiving ends 140 or a push-notification of specific groups can be performed to achieve the marketing effect of the web-push notification advertising network.

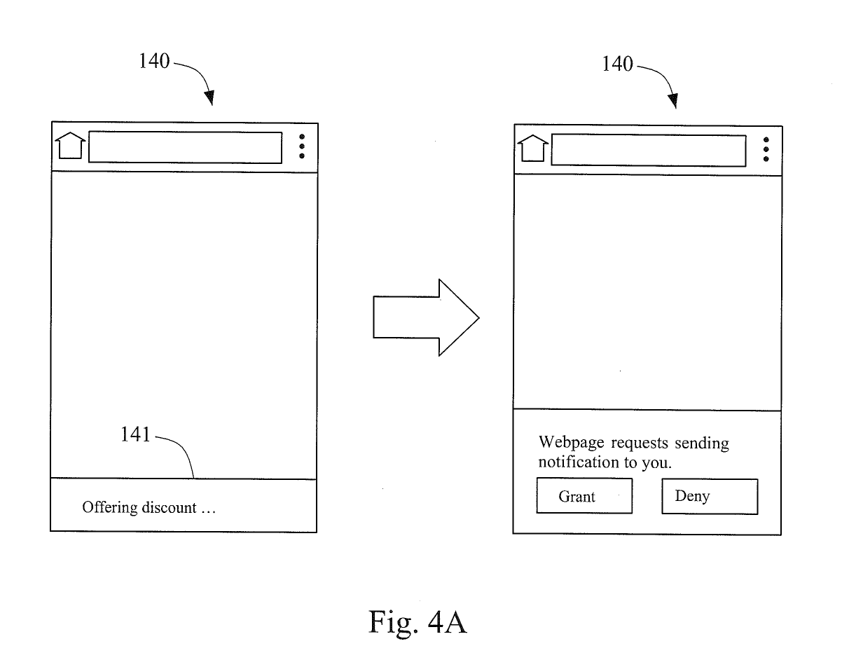

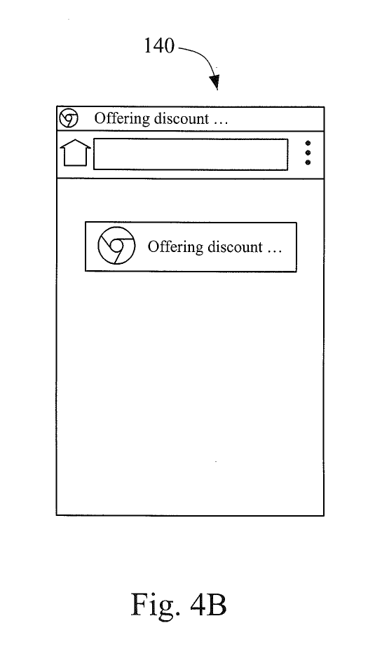

With reference to FIGS. 4A and 4B for the schematic views of a subscription in accordance with a preferred embodiment of the present invention, when a consumer user uses a browser of the receiving end 140 to browse a certain webpage, the secondary server 120 will display a banner advertisement 141 on the receiving end 140. When the consumer user clicks the banner advertisement 141, the secondary server 120 will send a request to the receiving end 140 to request the receiving end 140 for the push notification message. If the receiving end 140 clicks for permission, then the receiving end 140 will be able to receive the push notification message of the secondary server 120. In other words, the receiving end 140 establishes a subscription relation with the secondary server 120. When the receiving end 140 receives the push notification message, the push notification message will be displayed at the upper part of a screen and received by the webpage browser (as shown in FIG. 4B). In a preferred embodiment, the request for push-notification service is only granted at the first time when the receiving end 140 is connected to the secondary server 120 and situated in a non-subscribed status. After the receiving end 140 has completed the subscription, the request for push-notification will not be received anymore, but the consumer user can still be allowed to receive the push notification message through the setting of the browser of the receiving end 140.

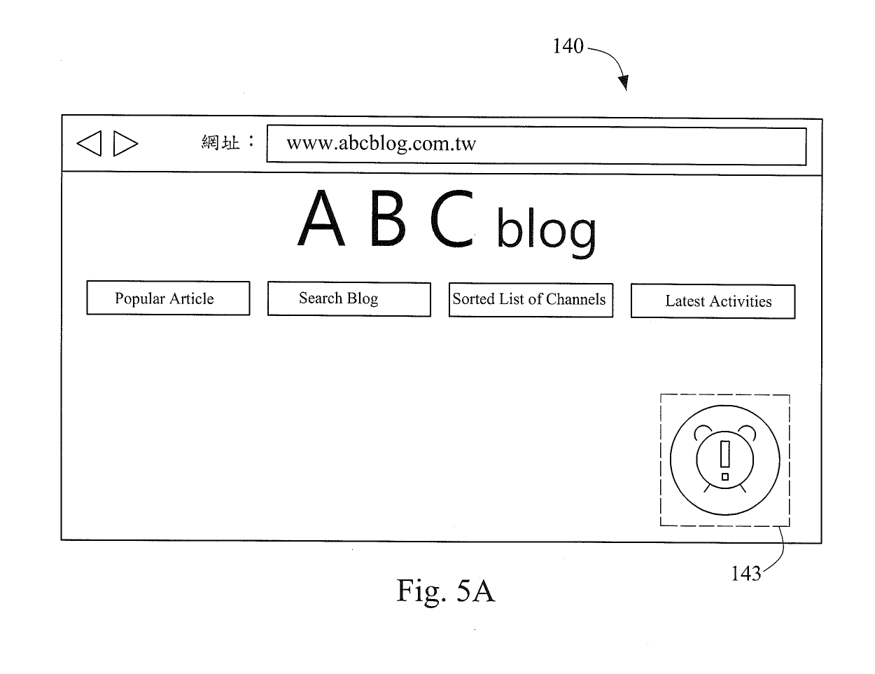

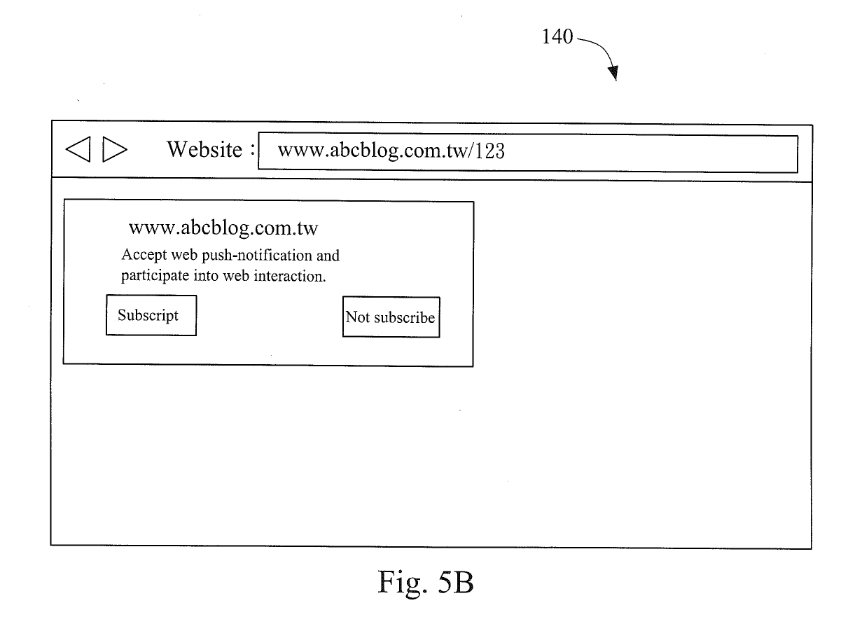

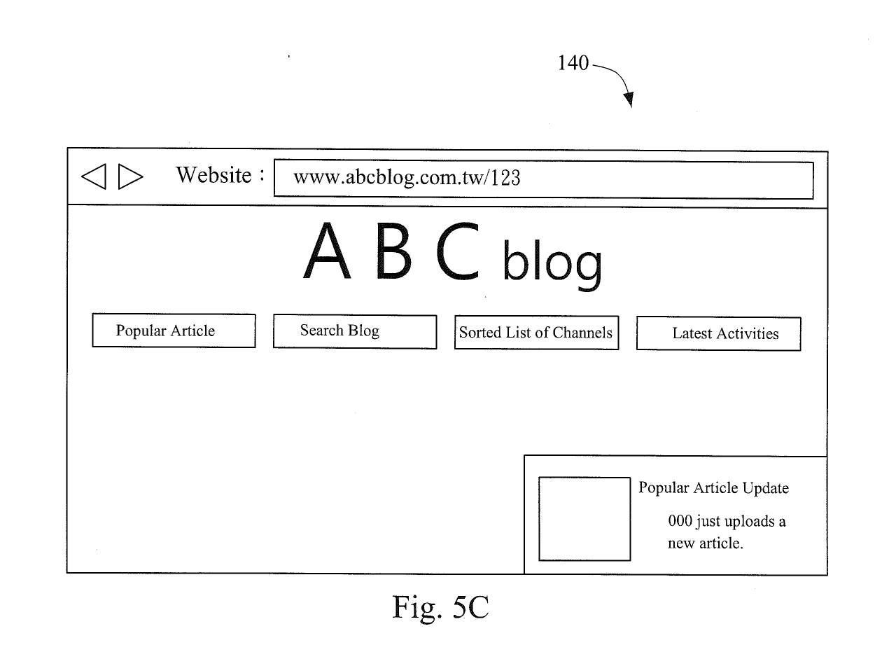

With reference to FIGS. 5A to 5C for the schematic views of another subscription in accordance with a preferred embodiment of the present invention, when the browser of the receiving end 140 browses a related webpage of the secondary server, an icon 143 (as shown in FIG. 5A) will be shown on the webpage. When a consumer user clicks the icon 143, the secondary server 120 will send a request to the receiving end 140 to request for a push notification message (as shown in FIG. 5B). If the receiving end 140 clicks and grants the request, the receiving end 140 can receive the push notification message of the secondary server 120. In other words, the receiving end 140 establishes a subscription relation with the secondary server 120. When the receiving end 140 receives the push notification message, the push notification message will be displayed at the lower right side of the screen, and received by the webpage browser (as shown in FIG. 5C).

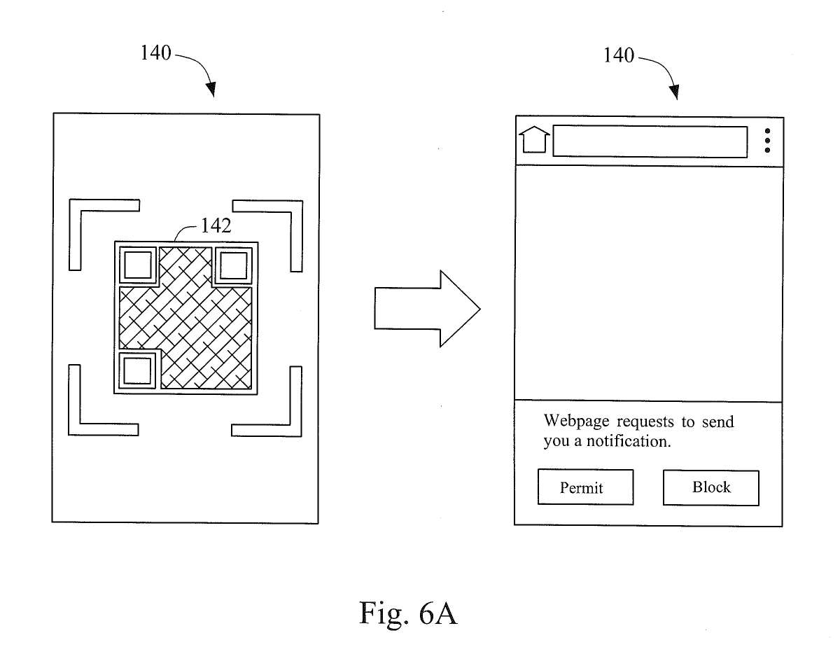

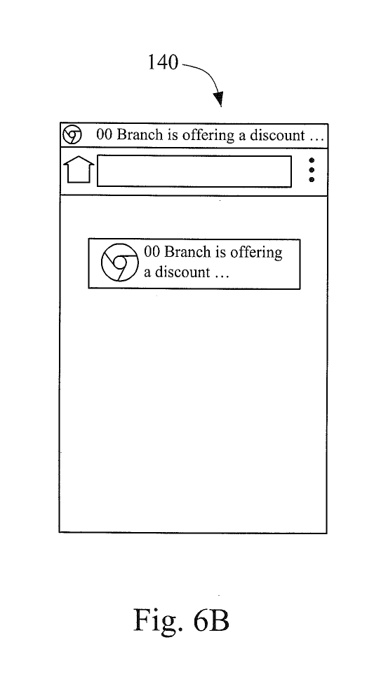

With reference to FIGS. 6A and 6B for the schematic views of another subscription in accordance with a preferred embodiment of the present invention, the consumer user may uses the receiving end 140 to shoot a barcode symbol 142 (as shown in FIG. 6A). The barcode symbol 142 includes an URL link. After obtaining the URL link, the receiving end 140 will start connecting the browser to the corresponding webpage, and then the secondary server 120 will send a request to the receiving end 140 for a push notification message (as shown in FIG. 6A). If the receiving end 140 clicks and grants the request, the receiving end 140 can receive the push notification message of the secondary server 120. In other words, the receiving end 140 establishes a subscription relation with the secondary server 120.

The web-push notification advertising network system 100 of the present invention improves the exposure of advertising by sending the push-notification messages to the consumer users, and collects the consumer user information from different webpages. In addition, the push notification messages may be screened by such consumer user information to aim at the target groups more accurately, so as to maximize the push-notification advertising effect.

While the invention has been described by means of specific embodiments, numerous modifications and variations could be made thereto by those skilled in the art without departing from the scope and spirit of the invention set forth in the claims.

What is claimed is:

1. A web-push notification advertising network system, comprising:
a plurality of secondary servers, each having a different domain name, and further including a push-notification function module;
a plurality of receiving ends, each being connected to at least one of the secondary servers;
a plurality of push-notification ends, and each of the secondary servers being connected to at least one of the push-notification ends; and
a main server, including a database, for storing user information of all of the receiving ends;
wherein, the push-notification end sends a push notification message to the corresponding receiving end by the push-notification function module through the secondary server; and
the secondary server sends to the push notification message to the non-corresponding receiving ends through the main server.

2. The web-push notification advertising network system of claim 1, wherein the receiving end receives the push notification message by a webpage browser.

3. The web-push notification advertising network system of claim 1, wherein the receiving end completes a subscription from the secondary server, so that the push notification message is received from the secondary server.

4. The web-push notification advertising network system of claim 1, wherein the receiving end completes a subscription according to the webpage corresponding to the secondary server.

5. The web-push notification advertising network system of claim 3, wherein the secondary server displays a banner advertisement on the receiving end, so that when a user clicks the banner advertisement, the subscription is completed by confirmation.

6. The web-push notification advertising network system of claim 3, wherein the receiving end shoots a barcode symbol to obtain a URL link and connect to the corresponding secondary server to complete the subscription.

7. The web-push notification advertising network system of claim 1, wherein the push-notification function module comprises:
a push-notification editing module, applicable for editing the push notification message; and
a push-notification sending module, applicable for sending the push notification message.

8. The web-push notification advertising network system of claim 3, wherein the user information includes the secondary server subscribed by the receiving end.
